(19) United States
(12) Patent Application Publication
(10) Pub. No.: US 2011/0075889 A1
(43) Pub. Date: Mar. 31, 2011

(54) IMAGE PROCESSING SYSTEM WITH AMBIENT SENSING CAPABILITY AND IMAGE PROCESSING METHOD THEREOF

(76) Inventor: Ying-Jieh Huang, Taipei County (TW)

(21) Appl. No.: 12/631,869

(22) Filed: Dec. 7, 2009

(30) Foreign Application Priority Data
Sep. 25, 2009 (TW) 098132392

(51) Int. Cl. G06K 9/00; H04N 5/228; G06K 9/46

(52) U.S. Cl. 382/107; 348/222.1; 382/190; 348/369

(57) ABSTRACT

An image processing system with ambient sensing capability includes an image sensing device and an ambient sensing device. The image sensing device is used for sensing a scene to generate original image data. The ambient sensing device is coupled to the image sensing device, for analyzing a part of the original image data to generate an ambient sensing result.

### BACKGROUND OF THE INVENTION

1. Field of the Invention

The present invention relates to an image processing system and related method, and more particularly, to an image processing system with ambient sensing capability and an image processing method thereof.

2. Description of the Prior Art

The advantages of a thin film transistor liquid crystal display (TFT-LCD) include portability, low power consumption, and low radiation. Therefore, the TFT-LCD is widely used in various portable products, such as notebooks, personal data assistants (PDAs), etc. Moreover, the TFT-LCD has gradually replaced the cathode ray tube (CRT) monitor in desktop computers. When a user watches the TFT-LCD, if the display screen of the TFT-LCD is too bright or a light is suddenly turned off, the pupil of their eye will be dilated; additionally, if the display screen remains bright, their eyes will be tired or even damaged. Therefore, the luminance of the display screen needs to be adjusted properly according to the ambient light intensity. The prior art design utilizes one or multiple dedicated photo detectors embedded in the computer device (e.g., notebook) to detect the ambient light intensity, so the illumination of the display screen or the backlight of a keyboard region can be adjusted automatically to obtain optimal brightness. Therefore, the user can easily and comfortably operate the computer device in a dark environment. However, a photo detector can only detect a light source that is located in a fixed direction. In order to perform light source detection or object movement detection in multiple directions, many photo detectors need to be utilized and the manufacturing cost is increased accordingly.

### SUMMARY OF THE INVENTION

It is therefore one of the objectives of the present invention to provide an image processing system with ambient sensing capability and an image processing method, that solves the above mentioned problems.

According to an embodiment of the present invention, an image processing system with ambient sensing capability is disclosed. The image processing system includes an image sensing device and an ambient sensing device. The image sensing device is used for sensing a scene to generate original image data. The ambient sensing device is coupled to the image sensing device, for analyzing a part of the original image data to generate an ambient sensing result.

According to another embodiment of the present invention, an image processing method is disclosed. The method includes the following steps: sensing a scene to generate original image data; and analyzing a part of the original image data to generate an ambient sensing result.

The exemplary embodiments of the present invention provide an image processing system with ambient sensing capability and an image processing method. An ambient sensing result can be derived by performing image segmentation and luminance variation/object movement analysis upon an original image data captured by an image sensing device, so the illumination of a display screen or the backlight of a keyboard region can be adjusted according to the ambient sensing result to provide convenience of use for a user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an image processing system according to an exemplary embodiment of the present invention.

FIG. 2 is a diagram illustrating a scene captured by the image sensing device shown in FIG. 1 via a fish-eye lens.

FIG. 3 is a diagram illustrating the image capturing viewpoints of the image sensing device shown in FIG. 1 positioned on an upper cover of a notebook.

FIG. 4 is a flowchart illustrating an image processing method according to an exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

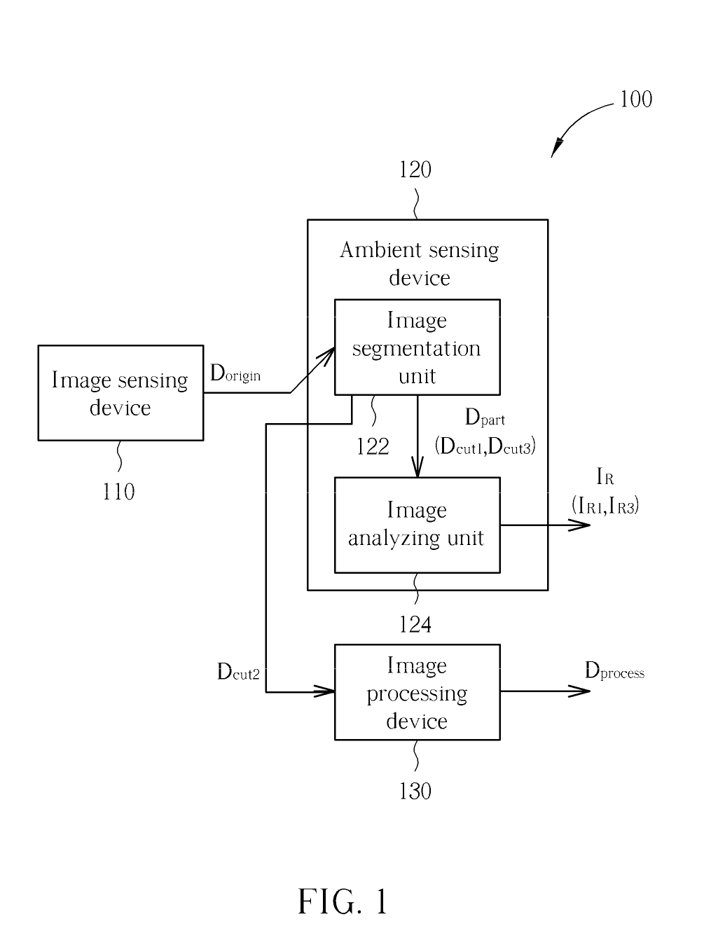

Please refer to FIG. 1. FIG. 1 is a diagram illustrating an image processing system 100 according to an exemplary embodiment of the present invention. In this embodiment, the image processing system 100 includes, but is not limited to, an image sensing device 110, an ambient sensing device 120 and an image processing device 130. The image sensing device 110 is used for sensing a scene to generate original image data D_{origin}. The ambient sensing device 120 is coupled to the image sensing device 110, and utilized for analyzing a partial image data Dₚₐᵣₜ of the original image data D_{origin} to generate an ambient sensing result I_{R}. The image processing device 130 is also coupled to the image sensing device 110, and utilized for generating a processed image data D_{process} according to the original image data D_{origin}.

The ambient sensing device 120 includes an image segmentation unit 122 and an image analyzing unit 124. The image segmentation unit 122 is used for receiving the original image data D_{origin}, and partitioning the original image data D_{origin} to generate a plurality of partitioned image data (e.g., D_{cut1}˜D_{cutN}) according to a plurality of sensing regions (e.g., S_{region1}˜S_{regionN}) of the image sensing device 110, where the plurality of partitioned image data correspond to the plurality of sensing regions, respectively. The image analyzing unit 124 is coupled to the image segmentation unit 122, and utilized for receiving at least one partitioned image data, and analyzing the at least one partitioned image data to generate the ambient sensing result I_{R}, wherein the partial image data Dₚₐᵣₜ includes at least one of the partitioned image data D_{cut1}˜D_{cutN}; additionally, the number of sensing regions can be adjusted according to the application requirements.

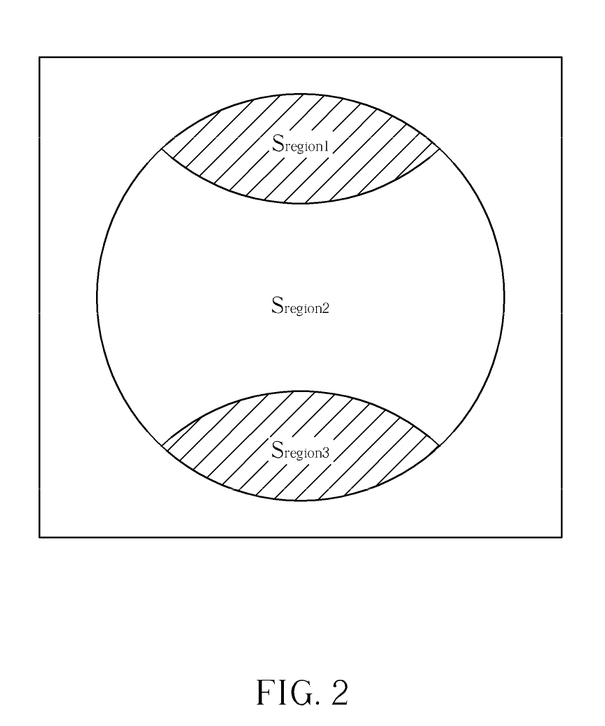

In one exemplary embodiment, the image sensing device 110 captures the scene to generate the original image data D_{origin} via a wide-angle lens or a fish-eye lens. The fish-eye lens is a particular wide-angle lens that takes in an extremely wide, hemispherical image, which takes in a 180° hemisphere and projects this as a circle within the scene. Please refer to FIG. 2 in conjunction with FIG. 1. FIG. 2 is a diagram illustrating a scene captured by the image sensing device 110 shown in FIG. 1 via the fish-eye lens. As shown in FIG. 2, the image sensing device 110 divides the scene captured by the fish-eye lens into three sensing regions S_{region1}˜S_{region3} (i.e., the above-mentioned S_{region1}˜S_{regionN}, where N is equal to 3). The image sensing device 110 sets the sensing regions S_{region1}, S_{region2} and S_{region3} as an ambient light sensing region, a normal image region and an object movement sensing region, respectively. Please note that, in this embodiment, the image sensing device 110 captures the image of the scene via the fish-eye lens and divides the captured image into three sensing regions; however, this embodiment merely serves as an example for illustrating the present invention, and should not be taken as a limitation to the scope of the present invention.

The image segmentation unit 122 receives the original image data D_{origin}, then partitions the original image data D_{origin} to generate the partitioned image data D_{cut1}˜D_{cut3} (i.e., the above-mentioned D_{cut1}˜D_{cutN}, where N is equal to 3) according to the sensing regions S_{region1}˜S_{region3} divided by the image sensing device 110, where the partitioned image data D_{cut1}˜D_{cut3} correspond to the sensing regions S_{region1}˜S_{region3}, respectively. The image analyzing unit 124 receives the partitioned image data D_{cut1} and D_{cut3}, and the image processing device 130 receives the partitioned image data D_{cut2}. Because the partitioned image data D_{cut1} corresponding to the sensing regions S_{region1} has been set as the ambient light sensing region, the image analyzing unit 124 performs luminance variation analysis upon the partitioned image data D_{cut1} to generate an ambient sensing result I_{R1}. Generally, light sources of a scene are positioned on the upper position (e.g., ceiling of a room), so the luminance variation analysis performed upon the partitioned image data D_{cut1} corresponding to the sensing regions S_{region1} located at the top of the scene can derive a fairly precise ambient sensing result. Since the fish-eye lens has a wider viewpoint, the sensing regions S_{region1} is difficult to be sheltered, and therefore the luminance variation analysis can derive the ambient sensing result with minimal error. The partitioned image data D_{cut2} corresponding to the sensing regions S_{region2} has been set as the normal image region, and the image captured by the wide-angle lens or the fish-eye lens will be warped. Therefore, the image processing device 130 performs a de-warp operation upon the partitioned image data D_{cut2} to generate the processed image data D_{process}. The partitioned image data D_{cut3} corresponding to the sensing regions S_{region3} has been set as the object movement sensing region, therefore, the image analyzing unit 124 performs object movement analysis upon the partitioned image data D_{cut3} to generate an ambient sensing result I_{R3}. Thus, the image sensing device 110 can perform ambient sensing and image processing simultaneously to generate the ambient sensing result I_{R} and the processed image data D_{process}.

Please note that, in this embodiment, the image processing device 130 performs image processing operations upon the partitioned image data D_{cut2}; however, this embodiment merely serves as an example for illustrating the present invention, and should not be taken as a limitation to the scope of the present invention. In an alternative design, the image processing device 130 can perform image processing operations upon the original image data D_{origin} directly to generate the processed image data D_{process}.

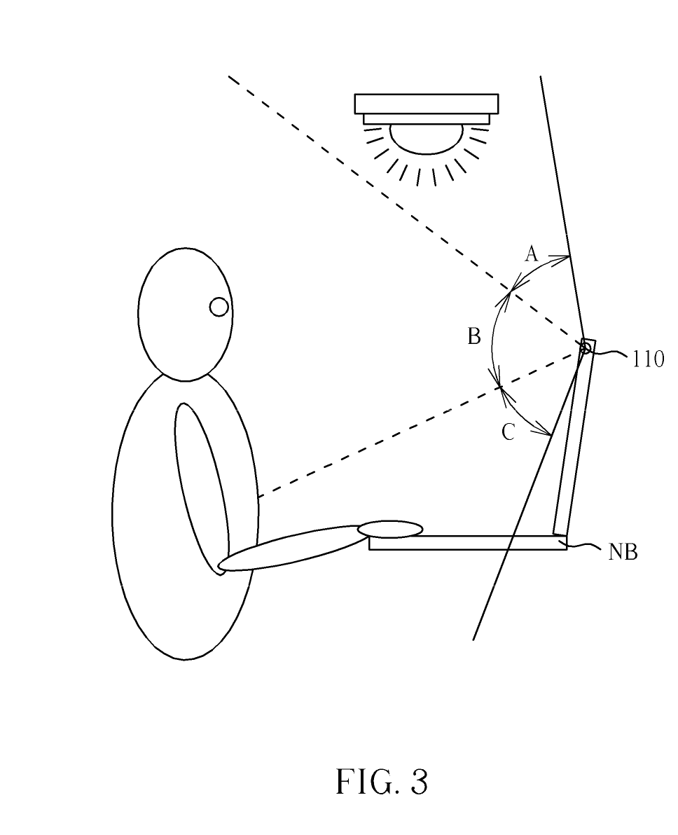

With the development of multimedia, the prices of small digital cameras have steadily dropped. In this new era, a computer can broadcast images over a network via the addition of one small digital camera. Therefore, a small digital camera has become standard equipment in a notebook. If the ambient sensing capability of the photo detector is replaced by the small digital camera, the manufacturing cost of the notebook can be greatly decreased. Therefore, in another exemplary embodiment, the image processing system 100 is applied in a notebook NB, and the image sensing device 110 is implemented by a small digital camera positioned on the upper cover of the notebook NB. Please refer to FIG. 3 in conjunction with FIG. 1 and FIG. 2. FIG. 3 is a diagram illustrating the image capturing viewpoints of the image sensing device 110 positioned on an upper cover of the notebook NB. As shown in FIG. 3, the capturing viewpoints A, B, C correspond to the sensing regions S_{region1}, S_{region2} and S_{region3} shown in FIG. 2, respectively. Because the light source of the scene is positioned at the sensing region S_{region1} covered by the capturing viewpoint A, the image analyzing unit 124 of the image processing system 100 performs the luminance variation analysis upon the partitioned image data D_{cut1} corresponding to the sensing regions S_{region1} to generate the ambient sensing result I_{R1}. As the normal image region is positioned at the sensing region S_{region2} covered by the capturing viewpoint B, the image processing device 130 of the image processing system 100 performs image processing operations upon the partitioned image data D_{cut2} corresponding to the sensing regions S_{region2} to generate the processed image data D_{process}. The keyboard of the notebook NB is positioned at the sensing region S_{region3} covered by the capturing viewpoint C, and information relating to human hand movement can be detected at the sensing region S_{region3}. The image analyzing unit 124 therefore performs the object movement analysis upon the partitioned image data D_{cut3} corresponding to the sensing regions S_{region3} to generate the ambient sensing result I_{R3}. If the image analyzing unit 124 transmits the ambient sensing result I_{R1} to a control device (not shown in FIG. 3) of the notebook NB, the control device can adjust the illumination of a display screen of the notebook NB or turn on/off the backlight of the keyboard according to the ambient sensing result I_{R1} for convenience of use by a user; if the image processing device 130 transmits the processed image data D_{process} to the control device of the notebook NB, the control device can display the processed image data D_{process} on the display screen according to user's requirement; additionally, if the image analyzing unit 124 transmits the ambient sensing result I_{R3} to the control device of the notebook NB, the control device can turn on/off the backlight of the keyboard according to the ambient sensing result I_{R3} for convenience of use by a user.

The abovementioned embodiments are presented merely for describing features of the present invention, and in no way should be considered to be limitations of the scope of the present invention. Those skilled in the art should readily appreciate that various modifications of the image sensing device 110 may be made for satisfying different requirements. For example, the image sensing device 110 can simply divide the captured scene into two sensing regions, and then the image analyzing unit 124 will perform luminance variation or object movement analysis upon a partitioned image data corresponding to one of the sensing regions to generate the ambient sensing result I_{R}. This also falls within the scope of the present invention.

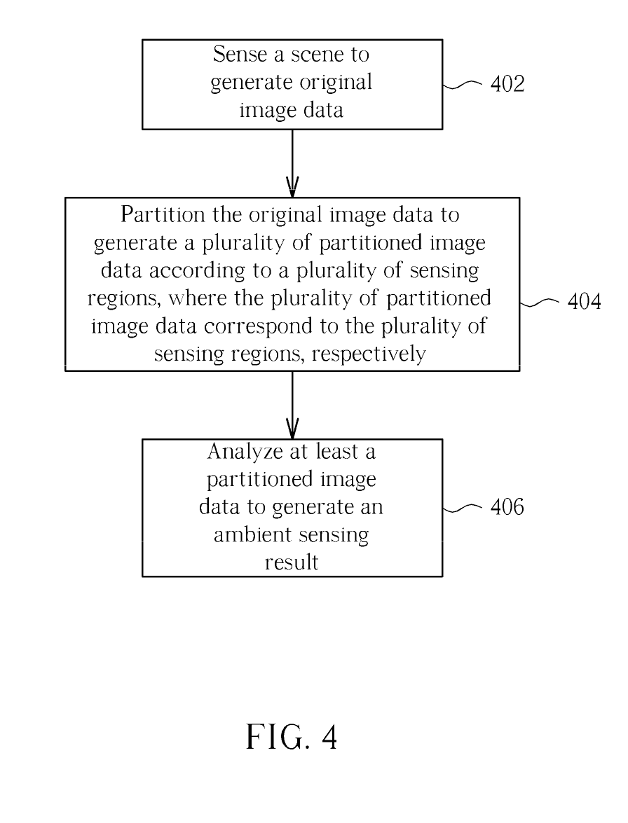

Please refer to FIG. 4. FIG. 4 is a flowchart illustrating an image processing method according to an exemplary embodiment of the present invention. The image processing method of the present invention can be applied to the image processing system 100 shown in FIG. 1. Please note that the following steps are not limited to be performed according to the sequence shown in FIG. 4 if a substantially identical result can be obtained. The exemplary method includes the following steps:

Step 402: Sense a scene to generate original image data.

Step 404: Partition the original image data to generate a plurality of partitioned image data according to a plurality of sensing regions, where the plurality of partitioned image data correspond to the plurality of sensing regions, respectively.

Step 406: Analyze at least a partitioned image data to generate an ambient sensing result.

As those skilled in this art can easily understand the operations of steps 402-406 of the exemplary image processing method after reading the disclosure of the image processing system 100 shown in FIG. 1, full details are omitted here for brevity. Please note that the steps of the flowchart mentioned above are merely a practicable embodiment of the present invention, and should not be taken as a limitation of the present invention. The method can include other intermediate steps or can merge several steps into a single step without departing from the spirit of the present invention.

In summary, the present invention provides an exemplary image processing system with ambient sensing capability. The image processing system performs image segmentation and luminance variation/object movement analysis upon an original image data captured by an image sensing device to generate an ambient sensing result so the illumination of a display or the backlight of a keyboard region can be adjusted according to the ambient sensing result to provide convenience of use for a user. In addition, the exemplary image processing system can also perform image processing operations upon the captured image data to generate processed image data simultaneously.

Those skilled in the art will readily observe that numerous modifications and alterations of the device and method may be made while retaining the teachings of the invention.

What is claimed is:

1. An image processing system with ambient sensing capability, comprising:
an image sensing device, for sensing a scene to generate original image data; and
an ambient sensing device, coupled to the image sensing device, for analyzing a partial image data of the original image data to generate an ambient sensing result.

2. The image processing system of claim 1, wherein the ambient sensing device comprises:
an image segmentation unit, for receiving the original image data, and partitioning the original image data to generate a plurality of partitioned image data according to a plurality of sensing regions of the image sensing device, where the plurality of partitioned image data correspond to the plurality of sensing regions, respectively, and the partial image data comprises at least one partitioned image data of the plurality of partitioned image data; and
an image analyzing unit, coupled to the image segmentation unit, for receiving the at least one partitioned image data, and analyzing the at least one partitioned image data to generate the ambient sensing result.

3. The image processing system of claim 2, wherein the plurality of sensing regions comprises at least a first sensing region and a second sensing region, the first sensing region corresponds to a first region of the scene, the second sensing region corresponds to a second region of the scene, the second region is located below the first region, and the at least one partitioned image data comprises a partitioned image data corresponding to the first sensing region.

4. The image processing system of claim 3, wherein the image analyzing unit performs luminance variation analysis upon the at least one partitioned image data to generate the ambient sensing result.

5. The image processing system of claim 2, wherein the plurality of sensing regions comprises at least a first sensing region and a second sensing region, the first sensing region corresponds to a first region of the scene, the second sensing region corresponds to a second region of the scene, the second region is located above the first region, and the at least one partitioned image data comprises a partitioned image data corresponding to the first sensing region.

6. The image processing system of claim 5, wherein the image analyzing unit performs object movement analysis upon the at least one partitioned image data to generate the ambient sensing result.

7. The image processing system of claim 1, further comprising:
an image processing device, coupled to the image sensing device, for generating a processed image data according to the original image data.

8. The image processing system of claim 1, wherein the ambient sensing device performs luminance variation analysis upon the partial image data to generate the ambient sensing result.

9. The image processing system of claim 1, wherein the ambient sensing device performs object movement analysis upon the partial image data to generate the ambient sensing result.

10. The image processing system of claim 1, wherein the image sensing device captures the scene to generate the original image data via a wide-angle lens or a fish-eye lens.

11. An image processing method, comprising:
sensing a scene to generate original image data; and
analyzing a partial image data of the original image data to generate an ambient sensing result.

12. The image processing method of claim 11, wherein the step of analyzing the partial image data of the original image data to generate the ambient sensing result comprises:
partitioning the original image data to generate a plurality of partitioned image data according to a plurality of sensing regions, where the plurality of partitioned image data correspond to the plurality of sensing regions, respectively, and the partial image data comprises at least one partitioned image data of the plurality of partitioned image data; and
receiving the at least one partitioned image data, and analyzing the at least one partitioned image data to generate the ambient sensing result.

13. The image processing method of claim 12, wherein the plurality of sensing regions comprises at least a first sensing region and a second sensing region, the first sensing region corresponds to a first region of the scene, the second sensing region corresponds to a second region of the scene, the second region is located below the first region, and the at least one partitioned image data comprises a partitioned image data corresponding to the first sensing region.

14. The image processing method of claim 13, wherein the step of analyzing the at least one partitioned image data to generate the ambient sensing result comprises:
performing luminance variation analysis upon the at least one partitioned image data to generate the ambient sensing result.

15. The image processing method of claim 12, wherein the plurality of sensing regions comprises at least a first sensing region and a second sensing region, the first sensing region corresponds to a first region of the scene, the second sensing region corresponds to a second region of the scene, the second region is located above the first region, and the at least one partitioned image data comprises a partitioned image data corresponding to the first sensing region.

16. The image processing method of claim 15, wherein the step of analyzing the at least one partitioned image data to generate the ambient sensing result comprises:
performing object movement analysis upon the at least one partitioned image data to generate the ambient sensing result.

17. The image processing method of claim 11, further comprising:
generating a processed image data according to the original image data.

18. The image processing method of claim 11, wherein the step of analyzing the partial image data of the original image data to generate the ambient sensing result comprises:
performing luminance variation analysis upon the partial image data to generate the ambient sensing result.

19. The image processing method of claim 11, wherein the step of analyzing the partial image data of the original image data to generate the ambient sensing result comprises:
performing object movement analysis upon the partial image data to generate the ambient sensing result.
